(19) United States
(12) Patent Application Publication
(10) Pub. No.: US 2012/0025124 A1
(43) Pub. Date: Feb. 2, 2012

(54) SERVICE VALVE BODY

(76) Inventors: Thomas C. Trent, Fort Wayne, IN (US); Dean Groff, Fort Wayne, IN (US)

(21) Appl. No.: 13/192,632

(22) Filed: Jul. 28, 2011

Related U.S. Application Data
(60) Provisional application No. 61/368,291, filed on Jul. 28, 2010.

(51) Int. Cl. F16K 27/00

(52) U.S. Cl. 251/366

(57) ABSTRACT

The present invention provides a service valve body for a heating/cooling system. The valve body has a main body, a charge port stem, and first and second stems, all of which are monolithic with one another (e.g., formed in one piece) such that there are no seams, joints, or brazed connections between the components. The charge port and valve stem contained therein may be angled relative to the axis of the first and/or second stem.

### CROSS REFERENCE TO RELATED APPLICATIONS

The present application claims the benefit of the filing date of U.S. Provisional Patent Application Ser. No. 61/368,291, filed Jul. 28, 2010, the disclosure of which is incorporated herein by reference in its entirety.

### BACKGROUND

A service valve body (part of condensing unit assembly) for a residential heating/cooling system (such as an air conditioning system or heat pump system) can be assembled by brazing copper field and factory stems to a brass body. Various configurations of the service valve body can include: a barstock body with a charge stem and two copper stems brazed in, a forged body with a charge stem and two copper stems brazed in, or a forged body with a charge stem forged with body and two copper stems brazed in. Each of these configurations requires the stems to be brazed, either by furnace or by torch. Brazing can be a very expensive manufacturing process, and can create additional cost due to scrap, rework, and customer returns.

### SUMMARY

The present invention provides a brazeless service valve body in which the components of the valve body, including the field and factory stems, are monolithic with one another. The service valve body does not have any brazed connections, seams, or joints. Elimination of the brazing process can lower the manufacturing cost of and reduce the amount of floor space necessary to build service valves in a manufacturing facility. Additionally, eliminating brazed connections, seams and joints from the valve body can increase the reliability of the service valve by eliminating potential leak paths through the valve body.

According to another aspect, the charge port stem contains a valve stem. The charge port stem and valve stem are angled relative to the axis of the first and/or second stems. In this manner, the service valve is easier for a technician to access for servicing the heating/cooling system.

According to one embodiment, the present invention provides a service valve body having a main body with an internal chamber. A charge port stem extends from the main body and has an opening and a passageway that is in fluid communication with the internal chamber. The valve body also has first and second stems that extend from the main body. The first stem has a passageway that is in fluid communication with the internal chamber and a distal end portion having an opening to the passageway. The second stem also has a passageway that is in fluid communication with the internal chamber and a distal end portion having an opening to the passageway. The main body, the first stem, the second stem, and the charge port stem are monolithic with one another.

According to one aspect, the first stem extends along a first axis and the charge port stem extends along an axis that is angled relative to the first axis. The first axis and the charge port axis may be in the same plane, or may be in planes that are perpendicular to one another.

According to another aspect, the main body is mated with a valve core to form a service valve.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The appended drawings show various features of embodiments of the invention.

FIG. 1 is an isometric view of an embodiment of a service valve body.

FIG. 2 is a side elevation view of the service valve body of FIG. 1.

FIG. 3 is a front elevation view of the service valve body of FIG. 1.

FIG. 4 is a section view of the service valve body taken along lines A-A of FIG. 3.

FIG. 5 is an isometric view of another embodiment of a service valve body.

FIG. 6 is a side elevation view of the service valve body of FIG. 5.

FIG. 7 is a front elevation view of the service valve body of FIG. 5.

FIG. 8 is a section view of the service valve body taken along lines B-B of FIG. 7.

FIG. 9 is a section view of the service valve body taken along lines C-C of FIG. 7.

FIG. 10 is a sectional view of an exemplary embodiment of a service valve installation having a service valve body substantially the same as that shown in FIGS. 1-4.

### DETAILED DESCRIPTION

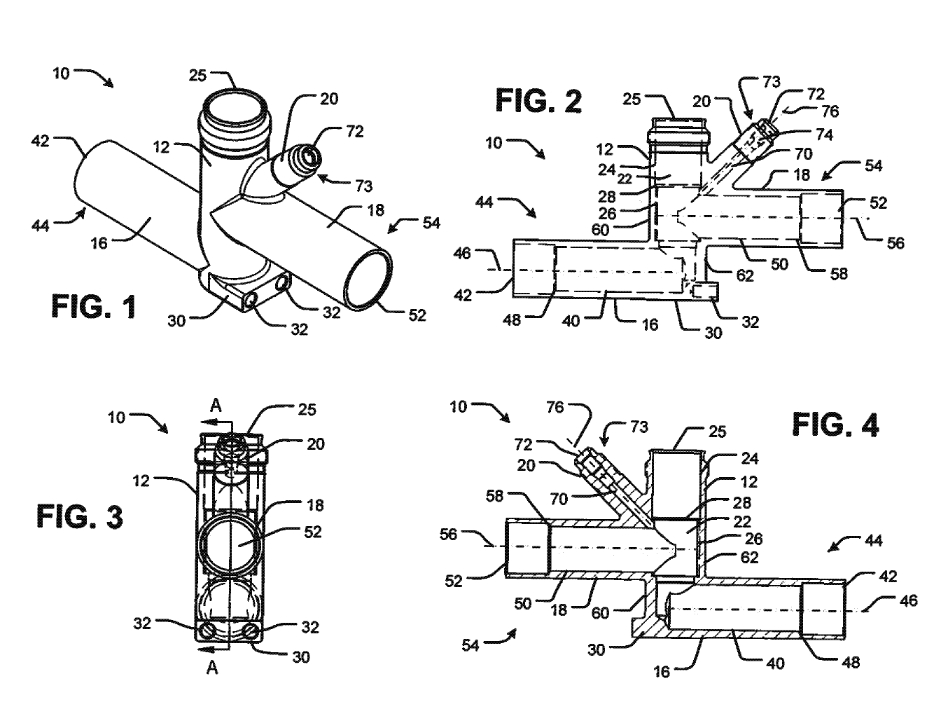

An exemplary embodiment of a service valve body 10 is shown in FIGS. 1-4. The service valve body 10 has a main body 12. Extending from the main body 12 is a first stem 16, a second stem 18, and a charge port stem 20. The main body 12, first stem 16, second stem 18 and charge port stem 20 are monolithic with one another (e.g., formed from a one-piece construction). The valve body 10 is free from any joints between the main body 12 and the stems. For example, the first stem 16, the second stem 18 and the charge port stem 20 extend from the main body 12 in a brazeless and seamless manner.

The service valve body 10 may be formed by a forging process. For example, a block of material may be forged into the rough outer shape of the main body 12, the first stem 16, the second stem 18 and the charge port stem 20. The valve body 10 can then be formed by a machining process, with the various passageways through the valve body being formed by machining bores through the stems. Other alterative manufacturing processes are also possible. For example, the valve body can be formed from a casting process with the various passageways through the stems being preformed by the casting. The valve body can then be machined into its final shape. As another alternative, the valve body can be manufactured by metal injection molding. Suitable metals for forming the valve body may include brass, aluminum, steel, and the like. Alternatively, the valve body may be formed from a plastic material, for example, by an injection molding process.

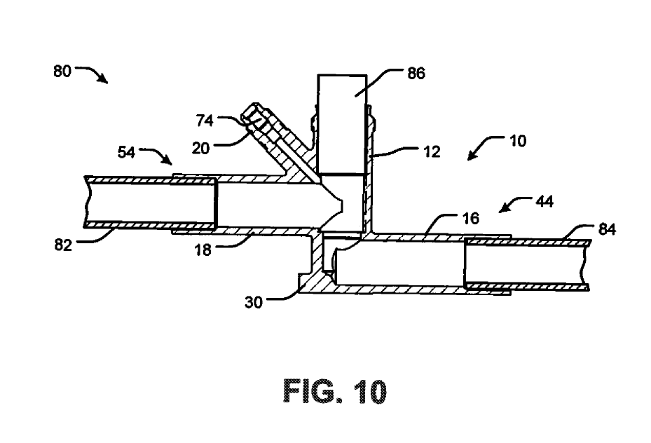

The various bores (described below) through the valve body 10 are connected to one another by an internal chamber 22 in the main body 12. The internal chamber 22 may be formed by a bore 24 in the main body 12 having an opening 25 through which a valve core can be inserted to form a service valve (see FIG. 10). The bore 24 may be configured to engage the valve core, for example, the bore 24 may have threads 26 and a shoulder 28 that provides a seat for the valve core and/or other internal components of the service valve (e.g., an elastomeric element, such as an O-ring).

As shown in FIGS. 1-4, the service valve body 10 has a base 30 at the opposite end of the opening 25. The base 30 may be monolithic with the main body 12 and may include one or more installation holes 32 for connecting the service valve body to another structure, for example, a structure within an air conditioning unit. Alternatively, the base may be formed separately from the main body, and the base and the main body may be coupled together by a weld, a connector, and/or another connecting mechanism.

One of the stems (e.g., the first stem 16) extends from a side of the main body 12 between the opening 25 and the base 30. The first stem 16 has a bore 40 that forms a passageway through the stem from an opening 42 at a distal end portion 44 of the stem to the internal chamber 22 such that the passageway is in fluid communication with the internal chamber. As shown in FIG. 2, the first stem 16 extends along axis 46. The bore 40 in the first stem 16 may include a shoulder 48 that provides a surface against which a conduit of a heating/cooling system may abut when the service valve is installed.

As shown in the embodiment of FIG. 1, the other stem (e.g., the second stem 18) extends from the main body 12 between the opening 25 and the base 30. The second stem 18 may extend from a side of the main body 12 opposite the first stem 16, although other configurations are possible. The second stem 16 has a bore 50 that forms a passageway through the second stem 18 from an opening 52 at a distal end portion 54 of the stem to the internal chamber 22 such that the passageway is in fluid communication with the internal chamber. As shown in FIG. 2, the second stem 16 extends along axis 56. The second stem axis 56 may be parallel to the first stem axis 46. The bore 50 in the second stem 18 may include a shoulder 58 that provides a surface against which a conduit of a heating/cooling system may abut when the service valve is installed in the system.

One of the stems may be a factory stem that is coupled to a conduit by a manufacturer of the heating/cooling system, and the other stem may be a field stem that is coupled to a conduit during installation of the heating/cooling system.

The distal end portion 44 of the first stem 16 and/or the distal end portion 54 of the second stem 18 can be configured for brazing the stem to a conduit of a heating/cooling system. For example, the distal end portion of the stem can be threadless. Additionally or alternatively, the distal end portion of the bore may include copper flashing to facilitate brazing of the stem to a copper conduit. Such brazed connections can be more reliable than threaded connections, which require fittings that can introduce leak paths and/or can be subject to failure.

If the valve body is formed from plastic, the distal end portions of the stems can be configured for connection to the conduits of the heating/cooling system by one or more fittings, such as compression fittings, quick couplers, and the like.

The distal end portions 44 and 54 of the stems 16 and 18 are spaced from the main body 12. As noted above, the internal chamber 22 in the main body 12 may contain heat-sensitive elements (such as O-rings or other elastomeric elements and the like). During installation, the first stem 16 and second stem 18 are typically brazed to the copper conduits of the heating/cooling system. Spacing the distal end portions of the stems from the main body reduces the likelihood that heat from brazing the conduit(s) to the valve body will damage the heat-sensitive elements contained therein.

The length of the first stem 14 and/or second stem 16 may be about 0.5 inches to about 2 inches as measured from the opening at the distal end of the stem to an outer wall of the main body (e.g., the length of the first stem 16 is measured from the opening 42 to an outer wall 60 of the main body 12, and the length of the second stem 18 is measured from the opening 42 to an outer wall 62 of the main body 12). In one embodiment, the length of the first stem and/or second stem is about 1.5 inches.

Also extending from the main body 12 is the charge port stem 20. The charge port stem 20 has a passageway 70 that is in fluid communication with the internal chamber 22 of the main body 12. The passageway 70 has an opening 72 at a distal end portion 73 of the charge port stem 20. The charge port stem also has a valve stem 74 disposed in the passageway 70. Refrigerant can be added or evacuated from the heating/cooling system through the valve stem 74 by coupling the valve stem 74 to a fluid supply line or vacuum line. As shown in FIG. 2, the charge port stem 20 and the valve stem 74 contained therein extend along axis 76.

The charge port stem axis 76 may be angled relative to the axis 46 of the first stem 16 and/or the axis 56 of the second stem 18. In one embodiment, the charge port stem axis 76 is in the same plane as the first stem axis 46. The charge port stem axis 76 may extend along an axis that is between about 30°-about 60° relative to the first stem axis 46. In the embodiment of FIGS. 1-4, the charge port stem axis 76 is angled about 45° relative to the axis of the first stem axis 46.

The angled charge port stem 20 can facilitate service of the heating/cooling system in which the service valve is installed. For example, it may be difficult for a technician to access a valve stem to charge/evacuate the system when the service valve is installed in a tight location of an air conditioner unit. By angling the charge port stem 20 (e.g., as shown in FIG. 1), the valve stem 74 is easier to access and therefore service of the heating/cooling system can be less cumbersome.

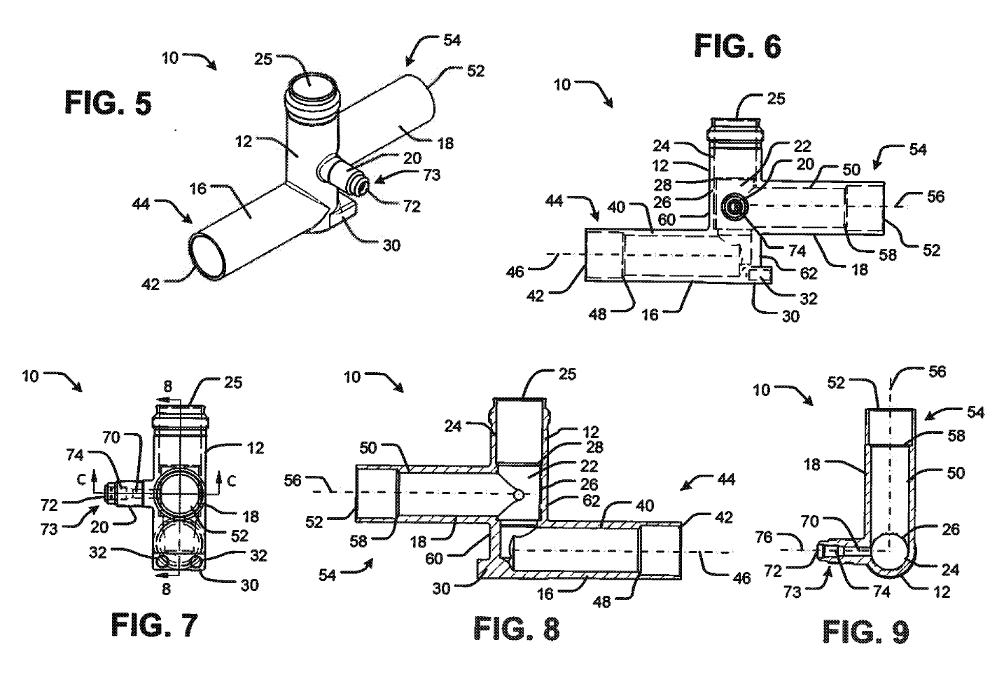

As shown in the embodiment of FIGS. 5-9, the charge port stem axis 76 can be perpendicular to the first stem axis 46 and/or the second stem axis 56. As shown, the charge port stem axis 76 is located in a plane that is perpendicular to the plane containing the first stem axis 46. Other than the location and orientation of the charge port stem, the valve body of FIGS. 5-9 is the same as that shown in FIGS. 1-4, and therefore for brevity the details will not be repeated.

Referring now to FIG. 10, a service valve 80 is shown. The service valve 80 has a valve core 86 (shown schematically) contained in a service valve body 10. In the illustrated embodiment, the service valve body 10 is substantially the same as the service valve body shown in FIGS. 1-4 although other configurations are possible, such as that shown in FIGS. 5-9.

The service valve 80 is shown coupled to conduits 82 and 84 of a heating/cooling system. The service valve 80 is installed into the heating/cooling system by brazing the distal end portion 44 of the first stem 16 and the distal end portion 54 of the second stem 18 to respective conduits 82 and 84 of the system. As noted above, the distal end portions 44, 54 of the first and second stems 16, 18 can be configured to facilitate the brazing of the service valve to copper conduits. For example, the bores may be coated with copper flashing to facilitate brazing of the stems to copper conduits.

The valve core 86 can be coupled to the main body 12 by a threaded connection. The valve core can be open/closed to start and stop the flow of refrigerant through the system during service of the system (e.g., when the system is being charged with refrigerant, or when the system is being evacuated).

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention. The features described with respect to one embodiment can be combined with features described with respect to another embodiment.

What is claimed is:

1. A service valve body comprising:
a main body having an internal chamber;
a charge port stem extending from the main body, the charge port stem having a passageway that is in fluid communication with the internal chamber and a distal end portion having an opening to the passageway;
a first stem extending from the main body, the first stem having a passageway that is in fluid communication with the internal chamber and a distal end portion having an opening to the passageway; and
a second stem extending from the main body, the second stem having a passageway that is in fluid communication with the internal chamber and a distal end portion having an opening to the passageway;
wherein the main body, the charge port stem, the first stem and the second stem are monolithic with one another.

2. The service valve body of claim 1, wherein the main body, the charge port stem, the first stem and the second stem have been forged from one piece of material.

3. The service valve body of claim 2, wherein the material is brass, aluminum or steel.

4. The service valve body of claim 1, wherein the distal end portion of the first stem is configured for brazing the first stem to a first conduit of a heating/cooling system.

5. The service valve body of claim 4, wherein the distal end portion of the second stem is configured for brazing the second stem to a second conduit of a heating/cooling system.

6. The service valve body of claim 5, further comprising copper flashing on at least one of the distal end portion of the first stem or the distal end portion of the second stem.

7. The service valve body of claim 1, wherein the first stem extends along a first axis and the charge port stem extends along an axis that is angled relative to the first axis.

8. The service valve body of claim 7, wherein the charge port stem extends along an axis that is angled between about 30°-about 60° relative to the first axis.

9. The service valve body of claim 7, wherein the charge port stem extends along an axis that is angled about 45° relative to the first axis.

10. The service valve of claim 7, wherein the first axis and the charge port stem axis are in the same plane.

11. The service valve body of claim 1, wherein the first stem extends along a first axis and the charge port stem extends along a charge port stem axis, and the first axis and the charge port stem axis are perpendicular to one another.

12. The service valve body of claim 1, wherein the length of at least one of the first stem and the second stem is between about 0.5 inches-2.0 inches.

13. The service valve body of claim 1, further comprising a valve stem disposed in the charge port stem passageway.

14. The service valve body of claim 1, further comprising a base at an end of the valve body, the base being monolithic with the main body.

15. The service valve body of claim 1 in combination with a conduit, wherein the conduit is brazed to one of the first distal end portion and the second distal end portion.

16. A service valve comprising the air conditioning service valve body of claim 1 and a valve core in the main body.

17. A service valve body comprising:
a main body having an internal chamber;
a charge port stem extending from the main body, the charge port stem having a passageway that is in fluid communication with the internal chamber and a distal end portion having an opening to the passageway, the charge port stem extending along a charge port stem axis;
a first stem extending from the main body, the first stem having a passageway that is in fluid communication with the internal chamber and a distal end portion having an opening to the passageway, the first stem extending along a first stem axis; and
a second stem extending from the main body, the second stem having a passageway that is in fluid communication with the internal chamber and a distal end portion having an opening to the passageway, the second stem extending along a second stem axis;
wherein the charge port stem axis is angled relative to the first stem axis and/or the second stem axis.
